(19) United States
(12) Patent Application Publication
(10) Pub. No.: US 2025/0372099 A1
(43) Pub. Date: Dec. 4, 2025

(54) METHOD AND SYSTEM FOR IMPROVING SPEECH RECOGNITION

(71) Applicant: Dell Products L.P., Round Rock, TX (US)

(72) Inventors: Sailendu Kumar Patra, Bangalore (IN); Saurabh Jha, Austin, TX (US); Rohitashwa Chakraborty, Konnagar (IN)

(21) Appl. No.: 18/732,143

(22) Filed: Jun. 3, 2024

(51) Int. Cl. G10L 17/18; G10L 17/02; G10L 17/04; G10L 25/18

(52) U.S. Cl. CPC G10L 17/18; G10L 17/02; G10L 17/04; G10L 25/18

(57) ABSTRACT

A method for managing a technical support conversation includes: obtaining, by an analyzer, an audio data and a transcript; converting, by the analyzer, the audio data to a Mel spectrogram (MS), in which the MS is provided to an augmentation module (AM) and the transcript is provided to a feature encoder; augmenting, by the AM, the MS to obtain an augmented MS, in which the augmented MS is provided to the feature encoder; analyzing, by the feature encoder, the augmented MS and transcript to generate feature vectors (FVs), in which the FVs are provided to an engine; analyzing, by the engine, the FVs to train a model; training, by the engine and using the FVs, the model to generate a trained model based on a target parameter; and initiating, by the engine, notification of an administrator about the trained model.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example, and are not meant to limit the scope of the claims.

FIG. 1 shows a diagram of a system in accordance with one or more embodiments disclosed herein.

FIG. 2.1 shows a diagram of an infrastructure node in accordance with one or more embodiments disclosed herein.

FIG. 2.2 shows a diagram of an engine in accordance with one or more embodiments disclosed herein.

FIG. 3.1 shows an example transcript of an audio file in accordance with one or more embodiments disclosed herein.

FIG. 3.2 shows an example transcript of an audio file in accordance with one or more embodiments disclosed herein.

FIG. 3.3 shows an example transcript of an audio file in accordance with one or more embodiments disclosed herein.

FIG. 3.4 shows an example transcript of an audio file in accordance with one or more embodiments disclosed herein.

FIG. 4.1 shows an example audio signal converted to a Mel spectrogram in accordance with one or more embodiments disclosed herein.

FIG. 4.2 shows an example Mel spectrogram with no augmentation is applied in accordance with one or more embodiments disclosed herein.

FIG. 4.3 shows an example augmented Mel spectrogram in accordance with one or more embodiments disclosed herein.

FIG. 4.4 shows an example augmented Mel spectrogram in accordance with one or more embodiments disclosed herein.

FIGS. 5.1 and 5.2 show a method for generating a trained speech recognition model in accordance with one or more embodiments disclosed herein.

FIG. 6 shows a method for performing speech recognition using the trained speech recognition model and a “trained” masked correction model in accordance with one or more embodiments disclosed herein.

FIG. 7 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, customer satisfaction rate is one of the key metrics for organizations/companies. To meet the demand and for better customer/user satisfaction/experience, there is a need for a conversational dialogue management system to facilitate, at least, the ability to understand human language and provide relevant information (e.g., to corresponding technical support staff, front-line representatives, etc.) to meet the customer's goal. Customers may want to spend less and less time and therefore may expect to be able to reach (or communicate with) an organization anytime and anywhere, regardless of time, location, and/or the communication channel. Because of that, organizations are constantly challenged by the competition to attract and retain customers to increase customer experience (and thereby customer satisfaction).

In most cases, customer handling is done through front-line representatives/agents. An agent may need to take a customer request via different media (e.g., call, chat, electronic mail, etc.) and send a response accordingly. Currently, front-line representatives spend a lot of time answering many simple queries, which might be delaying other pertinent customer issues. Besides, majority of customer communications are usually voice-based, and having a voice chatbot that can understand customer queries and provide an accurate, prompt response may aid in improving the quality of customer service. To this end, a voice-based conversation system may have a better appeal (to the customers) as it may provide an easier input method and faster hands-free experience. In addition, this kind of “speech-to-text” system may be used to transcribe contents of, for example, customer support calls, customer sales calls, voice commands, etc.

However, it is hard to manage huge amount of annotated/labeled data in speech and traditional automatic speech recognition (ASR) models (or traditional speech-to-text models) generally need large amount of data to be trained, or else these models do not generalize well across different customers (because, for example, the way User A speaks English may be different from the way User B speaks English, User D may have a different pitch tone comparing to User G, etc.). In speech recognition, most of the conventional ASR models employ augmentation, which involves deforming the audio waveform used by speeding the waveform up, slowing the waveform down, or adding background noise. On the other hand, most of the conventional ASR models have hundreds of millions of parameters that make them computing resource intensive and those models are built on open-source datasets.

In most cases, traditional speech recognition models are trained in an unsupervised way, in which one of these models may exploit large amount of unlabeled speech data to be first pre-trained and then to be fine-tuned on a smaller labeled dataset. Over the last years, this approach is preferred by many; however, the major drawback of conventional speech recognition models is that these models have to manage a large number of parameters (e.g., weights) as they learn from huge amount of data (e.g., unlabeled speech data). Besides, when the domain of pre-training is a bit different from that of the final use case, these models do not perform that well. One may argue that fine-tuning a pre-trained speech recognition model should help, but to fine-tune that model, lots of annotated data may still be required (which is quite computing resource intensive).

Further, most of the conventional correction models learn only from errors in the training data and because the error rate in a conventional ASR model is quite low, the training accuracy for a conventional correction model is quite low.

For at least the reasons discussed above and without requiring resource-intensive efforts (e.g., time, engineering, etc.), a fundamentally different approach/framework is needed (e.g., a framework that includes (i) an augmentation module (which employs a novel spectrogram augmentation method to improve a given ASR model's (or speech recognition model's (SRM)) performance and robustness while the model uses less amount of data, (ii) a feature encoder (which reduces the dimension of audio data with minimal loss of information), (iii) an acoustic model (which employs a parameter efficient architecture to convert audio output to text output), and (iv) a masked correction module (which helps in improving the final accuracy of the SRM)).

Embodiments disclosed herein relate to methods and systems for improving speech recognition. As a result of the processes discussed below, one or more embodiments disclosed herein advantageously ensure that: (i) a given SRM is trained with specific data (which is sourced and structured through a combination of workflows that includes speech collection, transcription, and annotation with various stages of validation along the way) so that a voice assistant (that operates based on a trained SRM) can conduct fluent, near-human-like conversations and enable smooth, helpful interactions with users; (ii) for the SRM to have the highest chance of success, the SRM is trained with data tailored and tuned to the specific scenarios the model will be operating in, considering any environmental factors and the multitude of competing noises that could effectively impair the model's understanding/hearing ability; (iii) novel augmentation techniques are introduced directly on an audio spectrogram (which helps in generating a robust SRM); (iv) a portion of “training” data is annotated and transcribed into text along with speaker tagging (while ensuring there is enough variability in the data in terms of gender, clarity, tone, pitch, etc., for a better user experience); (v) the data in (iv) is used for the development of the SRM that can accurately pick up the physical emission of sounds; (vi) an improved self-training mechanism for speech is used, where the mechanism employs labeled and unlabeled data at the same time to solve the “domain adaptation” problem; (vii) a combination of self-attention and convolution layers is used to generate the SRM (which allows the framework (a) to achieve maximum accuracy while using less computing resources and (b) to provide faster training and inference time); (viii) the speech-to-text process is performed in an efficient way using limited amount of annotated data; (ix) the framework performs well for different voice types and is parameter efficient (which allows the framework to be light on using computing resources); (x) as a unique approach to reach better speech recognition accuracy, the masked correction module is used (which effectively use a part of correct words along with the errors to better learn the speech's context); and/or (xi) an audio spectrogram is treated as an image problem and augmentation is introduced directly to the spectrogram (to force the SRM to generalize better using much less labeled data towards generating a robust speech-to-text model).

The following describes various embodiments disclosed herein.

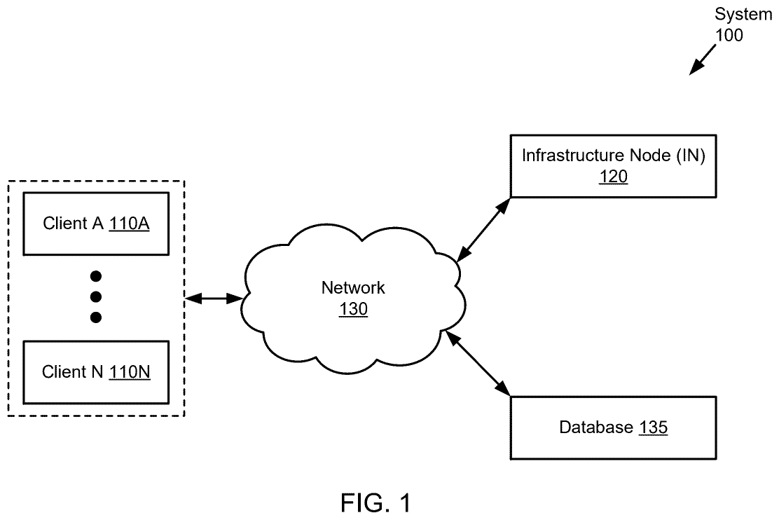

FIG. 1 shows a diagram of a system (100) in accordance with one or more embodiments disclosed herein. The system (100) includes any number of clients (e.g., Client A (110A), Client N (110N), etc.), a network (130), any number of infrastructure nodes (INs) (e.g., 120), and a database (135). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the IN (120), the network (130), and the database (135) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IN (120) are shown to be operatively connected through a communication network (e.g., 130), the clients (e.g., 110A, 110N, etc.) and the IN (120) may be directly connected (e.g., without an intervening communication network).

Further, the functioning of the clients (e.g., 110A, 110N, etc.) and the IN (120) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

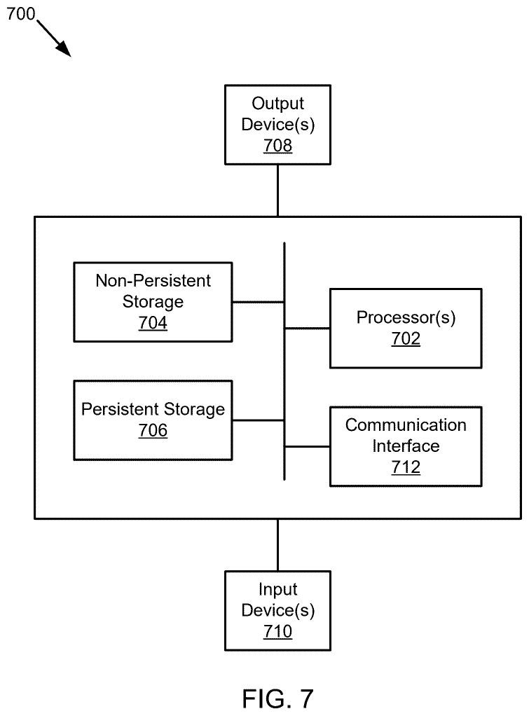

In one or more embodiments, the system (100) may be a distributed system (e.g., a data processing environment) and may deliver at least computing power (e.g., real-time (on the order of milliseconds (ms) or less) network monitoring, server virtualization, etc.), storage capacity (e.g., data backup), and data protection (e.g., software-defined data protection, disaster recovery, etc.) as a service to users of clients (e.g., 110A, 110N, etc.). For example, the system may be configured to organize unbounded, continuously generated data into a data stream. The system (100) may also represent a comprehensive middleware layer executing on computing devices (e.g., 700, FIG. 7) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using the clients (e.g., 110A, 110N, etc.)) and other computations remotely (e.g., away from the users' site using the IN (120)) from the users. By doing so, the users may utilize different computing devices (e.g., 700, FIG. 7) that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (120)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the IN (120). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN (120). When the clients interact with the IN, data that is relevant to the clients may be stored (temporarily or permanently) in the IN.

In one or more embodiments, a client (e.g., 110A, 110N, etc.) may be capable of, e.g.,: (i) collecting users' inputs, (ii) correlating collected users' inputs to the computer-implemented services to be provided to the users, (iii) communicating with the IN (120) that perform computations necessary to provide the computer-implemented services, (iv) using the computations performed by the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (120)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be taken into account without departing from the scope of the embodiments disclosed herein.

Further, in one or more embodiments, a client (e.g., 110A, 110N, etc.) may be implemented as a computing device (e.g., 700, FIG. 7). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, people, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 700, FIG. 7) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (120) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (120) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the database (135) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or ML models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide software-defined data protection for the clients (e.g., 110A, 110N, etc.); (xii) provide automated data discovery, protection, management, and recovery operations for the clients; (xiii) monitor operational states of the clients; (xiv) regularly back up configuration information of the clients to the database (135); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or database; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (120) may communicate with, for example, the database (135) and/or other storage devices in the system (100).

As described above, the IN (120) may be capable of providing a range of functionalities/services to the users of the clients (e.g., 110A, 110N, etc.). However, not all of the users may be allowed to receive all of the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (120) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (120) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN (120) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

Further, while a single IN (e.g., 120) is considered above, the term “node” includes any collection of systems or sub-systems that individually or jointly execute a set, or multiple sets, of instructions to provide one or more computer-implemented services. For example, a single IN may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (120) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (120) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

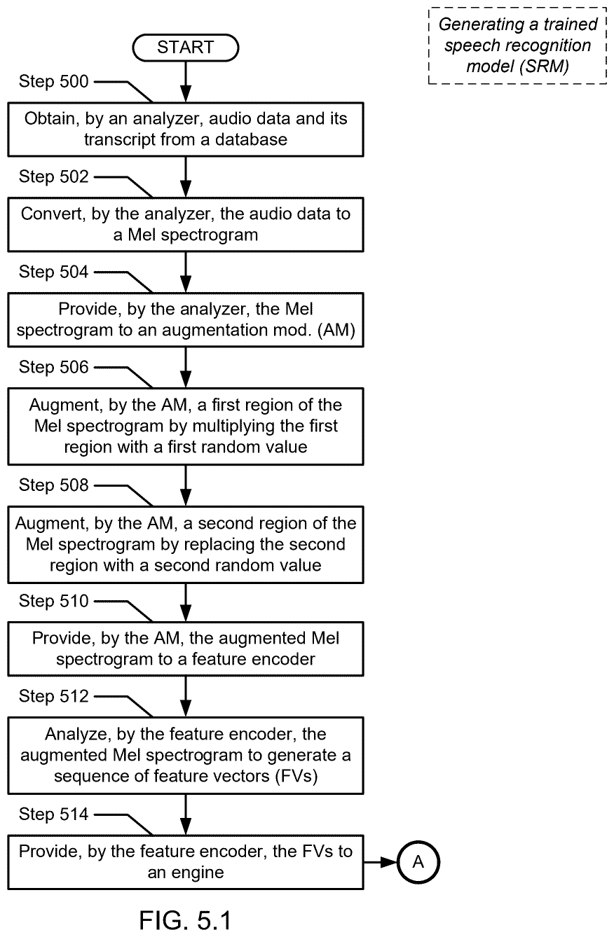

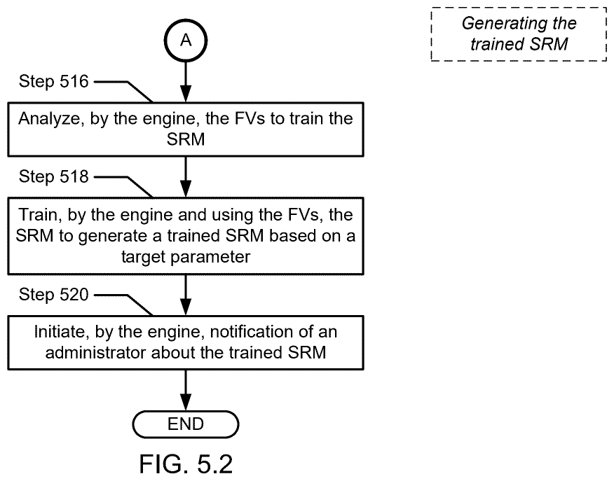

One of ordinary skill will appreciate that the IN (120) may perform other functionalities without departing from the scope of the embodiments disclosed herein. In one or more embodiments, the IN may be configured to perform (in conjunction with the database (135)) all, or a portion, of the functionalities described in FIGS. 5.1, 5.2, and 6.

In one or more embodiments, the IN (120) may be implemented as a computing device (e.g., 700, FIG. 7). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (120) may also be implemented as a logical device.

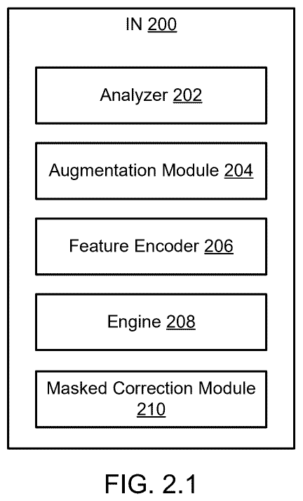

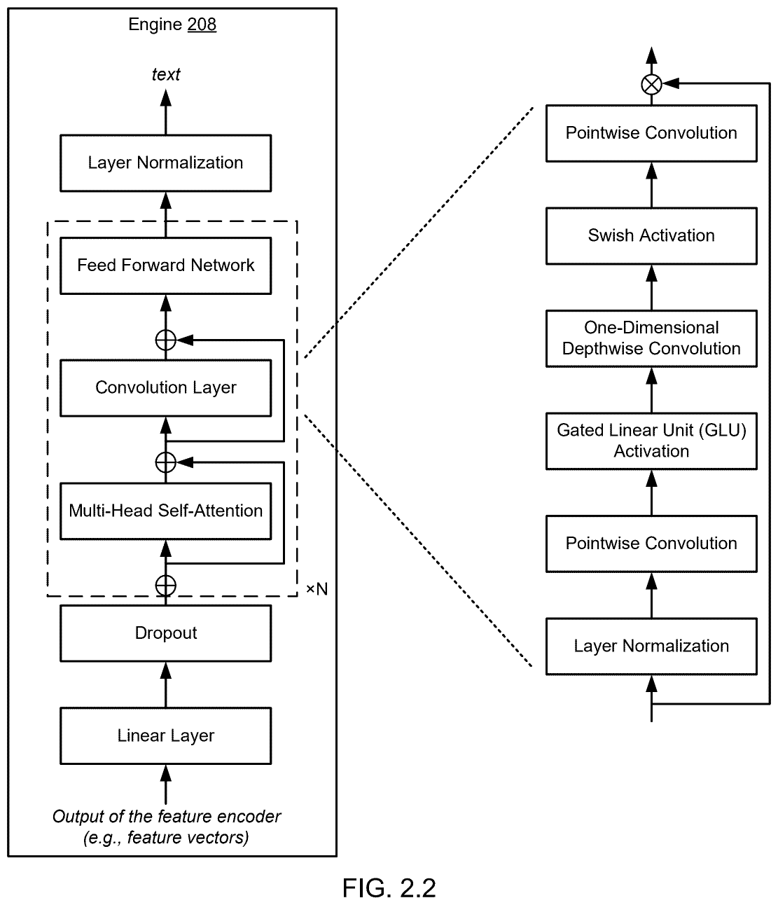

In one or more embodiments, the IN (120) may host an analyzer (e.g., 202, FIG. 2.1), an augmentation module (e.g., 204, FIG. 2.1), a feature encoder (e.g., 206, FIG. 2.1), an engine (e.g., 208, FIG. 2.1), and a masked correction module (e.g., 210, FIG. 2.1). Additional details of the analyzer, augmentation module, feature encoder, engine, and masked correction module are described below in reference to FIG. 2.1. In the embodiments of the present disclosure, the database (135) is demonstrated as a separate entity from the IN (120); however, embodiments disclosed herein are not limited as such. The database (135) may be demonstrated as a part of the IN (e.g., as deployed to the IN).

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN (120), etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

Turning now to the database (135), the database (135) may provide long-term, durable, high read/write throughput data storage/protection with near-infinite scale and low-cost. The database (135) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. Further, the database (135) may also occupy a portion of a physical storage/memory device or, alternatively, may span across multiple physical storage/memory devices.

In one or more embodiments, the database (135) may be implemented using physical devices that provide data storage services (e.g., storing data and providing copies of previously stored data). The devices that provide data storage services may include hardware devices and/or logical devices. For example, the database (135) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (135) may include a memory device (e.g., a dual in-line memory device), in which data is stored and from which copies of previously stored data are provided. As yet another example, the database (135) may include a persistent storage device (e.g., an SSD), in which data is stored and from which copies of previously stored data is provided. As yet another example, the database (135) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (135) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the database (135) may store/record unstructured and/or structured data that may include (or specify), for example (but not limited to): an identifier of a user/customer (e.g., a unique string or combination of bits associated with a particular user); a request received from a user (or a user's account); a geographic location (e.g., a country) associated with the user; a timestamp showing when a specific request is processed by an application; a port number (e.g., associated with a hardware component of a client (e.g., 110N)); a protocol type associated with a port number; computing resource details (including details of hardware components and/or software components) and an IP address details of an IN (e.g., 120) hosting an application where a specific request is processed; an identifier of an application; information with respect to historical metadata (e.g., system logs, applications logs, telemetry data including past and present device usage of one or more computing devices in the system (100), etc.); computing resource details and an IP address of a client that sent a specific request (e.g., to the IN (120)); one or more points-in-time and/or one or more periods of time associated with a data recovery event; data for execution of applications/services (including IN applications and associated end-points); corpuses of annotated data used to build/generate and train processing classifiers for trained ML models; linear, non-linear, and/or ML model parameters (e.g., instructions to the engine (e.g., 208, FIG. 2.1) on how to train and/or tune a model); an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; a distributed model identifier that uniquely identifies a distributed model; a user activity performed on a data item; a cumulative history of user/administrator activity records obtained over a prolonged period of time; a setting (and a version) of a mission critical application executing on an IN (e.g., 120); an SLA/SLO set by a user; a data protection policy (e.g., an affinity-based backup policy) implemented by a user (e.g., to protect a local data center, to perform a rapid recovery, etc.); a configuration setting of that policy; product configuration information associated with a client; a number of each type of a set of assets protected by an IN; a size of each of the set of assets protected; a number of each type of a set of data protection policies implemented by a user; configuration information associated with the analyzer (e.g., 202, FIG. 2.1) (to manage security, network traffic, network access, or any other function/operation performed by the analyzer); configuration information associated with the engine (e.g., 208, FIG. 2.1) (to manage security, network traffic, network access, or any other function/operation performed by the engine); a job detail of a job (e.g., a data protection job, a data restoration job, a log retention job, etc.) that has been initiated by an IN; a type of the job (e.g., a non-parallel processing job, a parallel processing job, an analytics job, etc.); information associated with a hardware resource set (discussed below) of the IN (120); a completion timestamp encoding a date and/or time reflective of a successful completion of a job; a time duration reflecting the length of time expended for executing and completing a job; a backup retention period associated with a data item; a status of a job (e.g., how many jobs are still active, how many jobs are completed, etc.); a number of requests handled (in parallel) per minute (or per second, per hour, etc.) by the analyzer (e.g., 202, FIG. 2.1); a number of errors encountered when handling a job; a documentation that shows how the analyzer performs against an SLO and/or an SLA; information regarding an administrator (e.g., a high priority trusted administrator, a low priority trusted administrator, etc.) related to an analytics job; a workflow (e.g., a policy that dictates how a workload should be configured and/or protected, such as an SQL workflow dictates how an SQL workload should be protected) set (by a user); a type of a workload that is tested/validated by an administrator per data protection policy; a practice recommended by a vendor (e.g., a single data protection policy should not protect more than 100 assets; for a dynamic NAS, maximum one billion files can be protected per day, etc.); one or more device state paths corresponding to a device (e.g., a client); an existing knowledge base (KB) article; a technical support history documentation of a customer/user; a port's user guide; a port's release note; a community forum question and its associated answer; a catalog file of an application upgrade; details of a compatible OS version for an application upgrade to be installed; an application upgrade sequence; a solution or a workaround document for a software failure; one or more lists that specify which computer-implemented services should be provided to which user (depending on a user access level of a user); a fraud report for an invalid user; a set of SLAs (e.g., an agreement that indicates a period of time required to retain a profile of a user); information with respect to a user/customer experience; audio data with its transcript (e.g., for training an SRM), a large corpus of text data including, at least, front-line agents' conversation (e.g., with customers) and business documents (e.g., domain/business specific agent (or technical support person) guide documents, domain specific policies, etc.) to train an ML; etc.

In one or more embodiments, audio data may be, for example (but not limited to), 45-hour of conversation data (where 6-hour portion of the data is annotated/labeled and 39-hour portion of the data is unlabeled). The audio data may be collected in the form of audio recordings, in which these recordings may include a dialog/conversation flow between a customer/user and a front-line representative (e.g., an agent) about, for example, a product delivery.

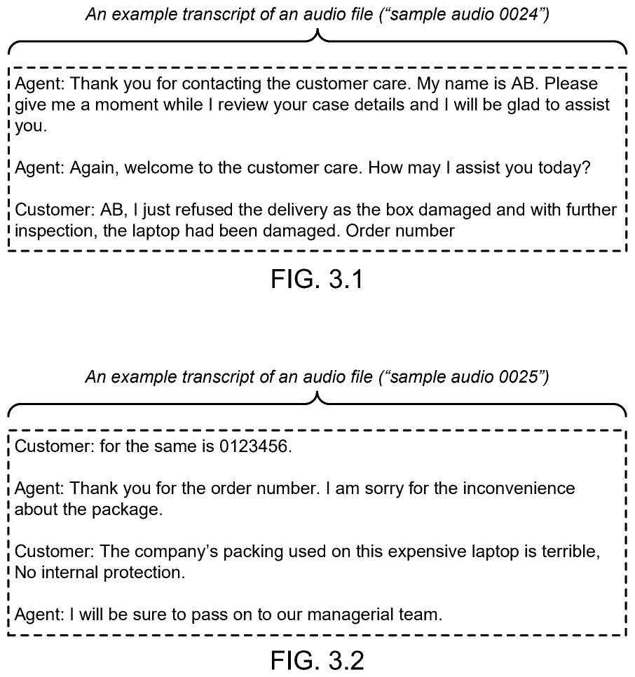

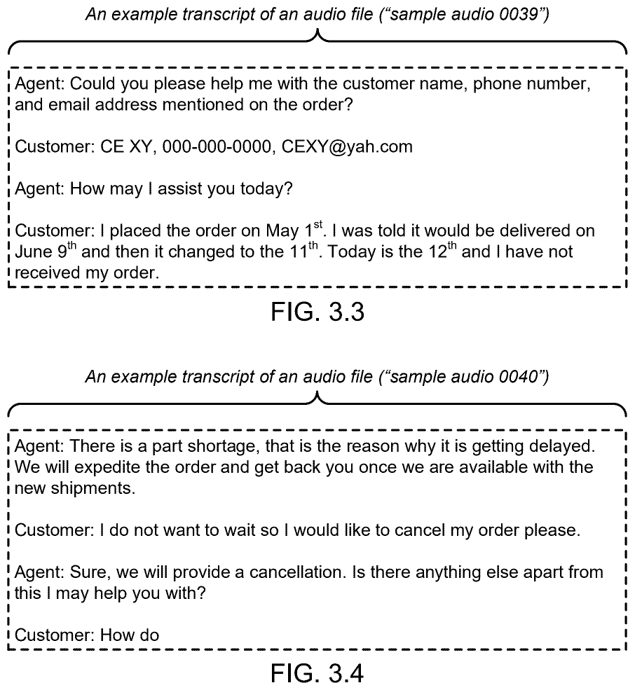

For annotating the audio data, the data (or the audio files) may be broken into one or more small “audio file” chunks (e.g., small chunks of 20-25 seconds each) and stored in, for example, the waveform audio file format. Then, one or more transcripts for the chunks (see FIGS. 3.1-3.4) may be tagged (for example, to specify the agent and customer) for future processing.

In one or more embodiments, information associated with a hardware resource set (e.g., including at least resource related parameters) may specify, for example (but not limited to): a configurable CPU option (e.g., a valid/legitimate vCPU count per IN in the system (100)), a configurable network resource option (e.g., enabling/disabling single-root input/output virtualization (SR-IOV) for the IN (120)), a configurable memory option (e.g., maximum and minimum memory per IN in the system (100)), a configurable GPU option (e.g., allowable scheduling policy and/or virtual GPU (vGPU) count combinations per IN in the system (100)), a configurable DPU option (e.g., legitimacy of disabling inter-integrated circuit (I2C) for various INs in the system (100)), a configurable storage space option (e.g., a list of disk cloning technologies across one or more INs in the system (100)), a configurable storage input/output (I/O) option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

In one or more embodiments, as being telemetry data, a system log (e.g., a file that records system activities across hardware and/or software components of a client, an internal lifecycle controller log (which may be generated as a result of internal testing of a NIC), etc.) may include (or specify), for example (but not limited to): a type of an asset (e.g., a type of a workload such as an SQL database, a NAS executing on-premises, a VM executing on a multi-cloud infrastructure, etc.) that is utilized by a user; computing resource utilization data (or key performance metrics including estimates, measurements, etc.) (e.g., data related to a user's maximum, minimum, and average CPU utilizations, an amount of storage or memory resource utilized by a user, an amount of networking resource utilized by user to perform a network operation, etc.) regarding computing resources of a client (e.g., 110A); an alert that is triggered in a client (e.g., based on a failed cloud disaster recovery operation (which is initiated by a user), the client may generate a failure alert); an important keyword associated with a hardware component of a client (e.g., recommended maximum CPU operating temperature is 75° C.); a computing functionality of a microservice (e.g., Microservice A's CPU utilization is 26%, Microservice B's GPU utilization is 38%, etc.); an amount of storage or memory resource (e.g., stack memory, heap memory, cache memory, etc.) utilized by a microservice (e.g., executing on a client); a certain file operation performed by a microservice; an amount of networking resource utilized by a microservice to perform a network operation (e.g., to publish and coordinate inter-process communications); an amount of bare metal communications executed by a microservice (e.g., I/O operations executed by the microservice per second); a quantity of threads (e.g., a term indicating the quantity of operations that may be handled by a processor at once) utilized by a process that is executed by a microservice; an identifier of a client's manufacturer; media access control (MAC) information of a client; an amount of bare metal communication executed by a client (e.g., I/O operations executed by a client per second); etc.

In one or more embodiments, an alert (e.g., a predictive alert, a proactive alert, a technical alert, etc.) may be defined by a vendor of a corresponding client (e.g., 110A), by an administrator, by another entity, or any combination thereof. In one or more embodiments, an alert may specify, for example (but not limited to): a medium-level of CPU overheating is detected, a recommended maximum CPU operating temperature is exceeded, etc. Further, an alert may be defined based on a data protection policy.

In one or more embodiments, an important keyword may be defined by a vendor of a corresponding client (e.g., 110A), by a technical support specialist, by the administrator, by another entity, or any combination thereof. In one or more embodiments, an important keyword may be a specific technical term or a vendor specific term that is used in a system log.

In one or more embodiments, as being telemetry data, an application log may include (or specify), for example (but not limited to): a type of a file system (e.g., a new technology file system (NTFS), a resilient file system (ReFS), etc.); a product identifier of an application; a version of an OS that an application is executing on; a display resolution configuration of a client; a health status of an application (e.g., healthy, unhealthy, etc.); warnings and/or errors reported for an application; a language setting of an OS; a setting of an application (e.g., a current setting that is being applied to an application either by a user or by default, in which the setting may be a font option that is selected by the user, a background setting of the application, etc.); a version of an application; a warning reported for an application (e.g., unknown software exception (0xc00d) occurred in the application at location 0x0007d); a version of an OS; a type of an OS (e.g., a workstation OS); an amount of storage used by an application; a size of an application (size (e.g., 5 Megabytes (5 MB), 5 GB, etc.) of an application may specify how much storage space is being consumed by that application); a type of an application (a type of an application may specify that, for example, the application is a support, deployment, or recycling application); a priority of an application (e.g., a priority class of an application, described below); active and inactive session counts; etc.

As used herein, “unhealthy” may refer to a compromised health state (e.g., an unhealthy state), indicating a corresponding entity (e.g., a hardware component, a client, an application, etc.) has already or is likely to, in the future, be no longer able to provide the services that the entity has previously provided. The health state determination may be made via any method based on the aggregated health information without departing from the scope of the embodiments disclosed herein.

In one or more embodiments, a priority class may be based on, for example (but not limited to): an application's tolerance for downtime, a size of an application, a relationship (e.g., a dependency) of an application to other applications, etc. Applications may be classified based on each application's tolerance for downtime. For example, based on the classification, an application may be assigned to one of three classes such as Class I, Class II, and Class III. A “Class I” application may be an application that cannot tolerate downtime. A “Class II” application may be an application that can tolerate a period of downtime (e.g., an hour or other period of time determined by an administrator or a user). A “Class III” application may be an application that can tolerate any amount of downtime.

In one or more embodiments, metadata (e.g., system logs, application logs, etc.) may be obtained (or dynamically fetched) as they become available (e.g., with no user manual intervention), or by the analyzer (e.g., 202, FIG. 2.1) polling a corresponding client (e.g., 110A) (by making schedule-driven/periodic application programming interface (API) calls to the client without affecting the client's ongoing production workloads) for newer metadata. Based on receiving the API calls from the analyzer, the client may allow the analyzer to obtain the metadata.

In one or more embodiments, the metadata may be obtained (or streamed) continuously as they generated, or they may be obtained in batches, for example, in scenarios where (i) the analyzer (e.g., 202, FIG. 2.1) receives a metadata analysis request (or a health check request for a client), (ii) another IN of the system (100) accumulates the metadata and provides them to the analyzer at fixed time intervals, or (iii) the database (135) stores the metadata and notify the analyzer to access the metadata from the database. In one or more embodiments, metadata may be access-protected for a transmission from a corresponding client (e.g., 110A) to the analyzer (e.g., 202, FIG. 2.1), e.g., using encryption.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the database (135), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): newer system logs are received, a state of the analyzer (e.g., 202, FIG. 2.1) is changed, etc.

While the database (135) has been illustrated and described as including a limited number and type of data, the database (135) may store additional, less, and/or different data without departing from the scope of the embodiments disclosed herein. One of ordinary skill will appreciate that the database (135) may perform other functionalities without departing from the scope of the embodiments disclosed herein.

While FIG. 1 shows a configuration of components, other system configurations may be used without departing from the scope of the embodiments disclosed herein.

Turning now to FIG. 2.1, FIG. 2.1 shows a diagram of an IN (200) in accordance with one or more embodiments disclosed herein. The IN (200) may be an example of the IN discussed above in reference to FIG. 1. The IN (200) includes the analyzer (202), the augmentation module (204), the feature encoder (206), the engine (208), and the masked correction module (210). The IN (200) may include additional, fewer, and/or different components without departing from the scope of the embodiments disclosed herein. Each component may be operably connected to any of the other component via any combination of wired and/or wireless connections. Each component illustrated in FIG. 2.1 is discussed below.

In one or more embodiments, the analyzer (202) may include functionality to, e.g.,: (i) receive/obtain distributed metadata (e.g., distributed logs) coming from different clients to get a logical view of all logs relevant to process a specific request (e.g., received from an administrator); (ii) use parameters/details available in distributed logs in order to, at least, (a) trace a specific request through a distributed system (e.g., 100, FIG. 1), (b) identify potential errors (e.g., performance issues) occurred while processing the specific request (e.g., which application was down while processing the specific request, what caused that application to went down, etc.), (c) trace requests that display high-latency across all applications (e.g., microservices), (d) in conjunction with the engine (208), reduce mean time to troubleshooting performance issues, (e) in conjunction with the engine (208), get immediate root cause identification of every application impact, and (f) improve user experience by re-establishing end-to-end interoperability; (iii) based on (ii), infer dependencies and connectivity among applications executing on the system (e.g., which applications are working together, which ports are open, etc.); (iv) monitor performance (e.g., a health status) of a client (e.g., 110A, FIG. 1) by obtaining telemetry data (e.g., metadata, computing resource utilization data (or key performance metrics) of hardware and/or software components, etc.) associated with the client; (v) based on (iv) and for each hardware or software component (of the client), derive a continuous average resource utilization value with respect to each computing resource; (vi) based on (iv) and for each hardware or software component (of the client), derive minimum and maximum resource utilization values with respect to each computing resource; (vii) identify health of each component based on average, minimum, and maximum resource utilization values; (viii) based on (vii), automatically react and generate alerts if one of the predetermined maximum resource utilization value thresholds is exceeded; (ix) provide identified health of each component (and, indirectly, health of the client) and generated alerts (if any) to other entities (e.g., 208) in order to manage the health of the client; and/or (x) store monitored resource utilization data and generated alerts (if any) to the database (e.g., 135, FIG. 1) to generate a resource utilization map.

In one or more embodiments, the resource utilization map may be implemented using one or more data structures that include information regarding the utilization of computing resources (e.g., a hardware resource, a software resource, a CPU, memory, etc.) of the IN (e.g., 120, FIG. 1) and/or the client (e.g., 110A, FIG. 1). The resource utilization map may specify, for example (but not limited to): an identifier of a microservice, an identifier of a computing resource, an identifier of a resource that has been utilized by a microservice, etc.

The resource utilization map may specify the resource utilization by any means. For example, the resource utilization map may specify an amount of utilization, resource utilization rates over time, power consumption of applications/microservices while utilized by a user, workloads performed using microservices, etc. The resource utilization map may include other types of information used to quantify the utilization of resources by microservices without departing from the scope of the embodiments disclosed herein.

In one or more embodiments, the resource utilization map may be maintained by, for example, the analyzer (202). The analyzer (202) may add, remove, and/or modify information included in the resource utilization map to cause the information included in the resource utilization map to reflect the current utilization of the computing resources. Data structures of the resource utilization map may be implemented using, for example, lists, tables, unstructured data, structured data, etc. While described as being stored locally, the resource utilization map may be stored remotely and may be distributed across any number of devices without departing from the scope of the embodiments disclosed herein.

In one or more embodiments, while monitoring, the analyzer (202) may need to, for example (but not limited to): inventory one or more hardware and/or software components of a client (e.g., 110A, FIG. 1); obtain type and model information of each component of a client; obtain a version of firmware or other code executing on a component of a client (e.g., a microservice executing on the client); obtain information specifying each component's interaction with one another in a client and/or with another component of a second client; etc.

In one or more embodiments, the analyzer (202) may derive minimum and maximum resource utilization values (with respect to each computing resource) as a reference to infer whether a continuous average resource utilization value (with respect to each computing resource) is derived properly. If there is an issue with the derived continuous average resource utilization value, based on the reference, the analyzer (202) may re-derive the continuous average resource utilization value.

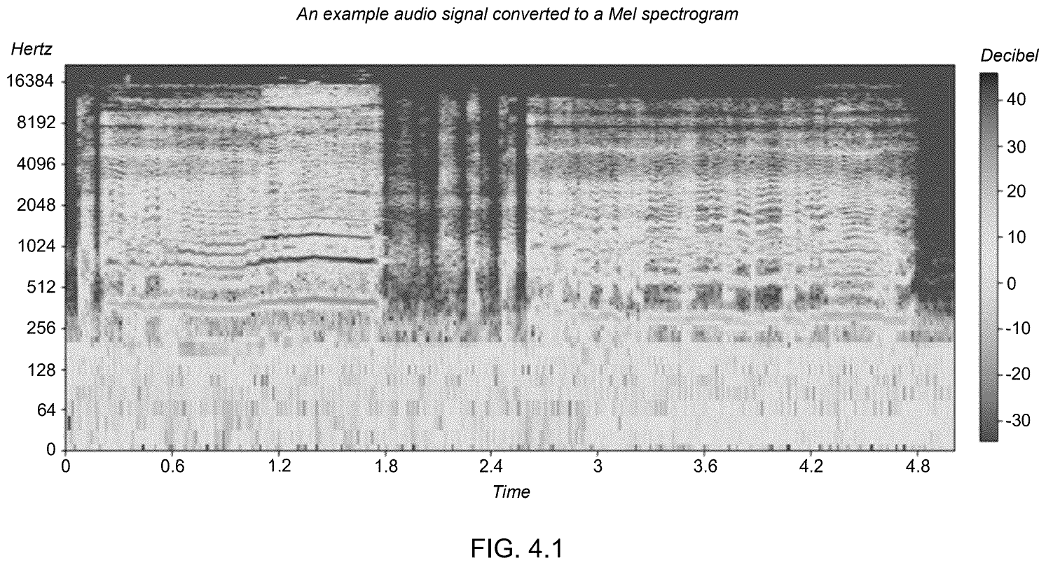

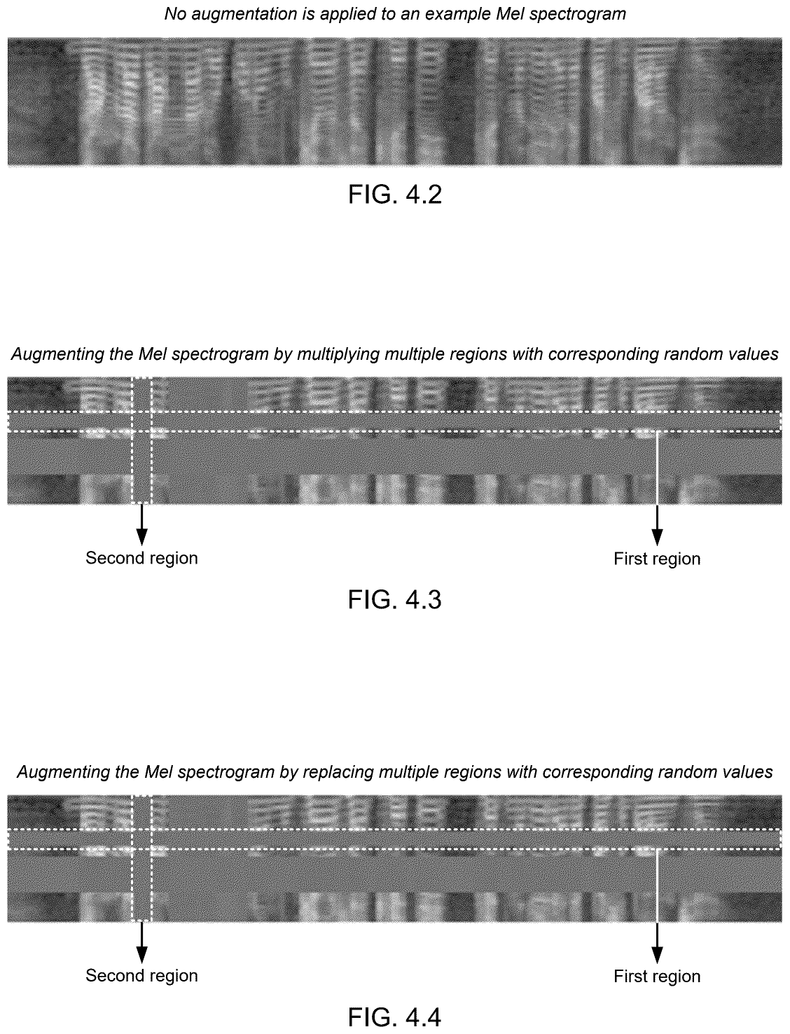

Further, the analyzer (202) may include functionality to, e.g.,: (i) obtain/retrieve audio data and its transcript from the database (e.g., 135, FIG. 1); (ii) by employing a linear model, a non-linear model, and/or a ML model, convert the audio data to a Mel spectrogram (see e.g., FIG. 4.1); and/or (iii) provide the Mel spectrogram to the augmentation module (204).

In general, speech can be defined as a combination of signals at different frequencies. A signal may produce different sounds as the signal varies over time, and because of that, the signal's constituent frequencies may also vary with time. A spectrogram of the signal may plot the signal's spectrum over time, in which the spectrogram may be defined as a “photograph” of the signal. The spectrogram may plot “time” on the x-axis and “frequency” on the y-axis, and may use different colors to indicate the amplitude/strength of each frequency. For example, a bright color may indicate high-energy signal. Further, each vertical slice of the spectrogram may be the spectrum of the signal at that instant time and show how the signal strength is distributed in every frequency found in the signal at that instant.

The spectrogram may be generated using one or more Fourier transforms to decompose the signal into the signal's constituent frequencies. In most cases, human ears are more sensitive to pitch of the sound rather than the difference in frequency and, to this end, the “Mel scale” was developed to take into account how humans perceive frequencies. As used herein, the “Mel scale” is a scale of pitches, where each unit of pitch is judged by humans to be equal (in pitch distance) from the next. Further, the human perception of the amplitude of a sound is the sound's loudness, and similar to frequency, humans hear loudness logarithmically (rather than linearly).

A Mel spectrogram (see e.g., FIG. 4.1) makes two changes relative to a “regular” spectrogram that plots “frequency” versus “time”: (i) the Mel spectrogram uses the “Mel scale” instead of “frequency” on the y-axis and (ii) the Mel spectrogram uses the “decibel scale” instead of “amplitude” to indicate colors.

For at least the aforementioned reasons and to better analyze an audio signal, the analyzer (202) may convert the audio signal to a Mel spectrogram.

One of ordinary skill will appreciate that the analyzer (202) may perform other functionalities without departing from the scope of the embodiments disclosed herein. The analyzer (202) may be implemented using hardware (e.g., a physical device including circuitry), software, or any combination thereof.

In general, one of the major challenges for an SRM (which includes multiple parameters) is that the SRM tends to overfit training data and, because of that, the SRM may not operate as expected when (i) unseen data is provided as input and (ii) the training data is not extensive enough. Data augmentation is a useful technique in such scenarios to improve the performance of the SRM (by forming different datasets from training data) and to improve the robustness of the SRM (in terms of overfitting).

In the case of speech recognition, data augmentation traditionally involves deforming the audio waveform (used for training the SRM) in some fashion (e.g., by speeding the waveform up, by slowing the waveform down, by adding background noise to the waveform, etc.). However, instead of augmenting an audio waveform, the augmentation module (204) augments a Mel spectrogram (which is received/obtained from the analyzer (202)), where augmenting the Mel spectrogram is a resource efficient and more effective (in terms of speech recognition) process. To this end, the augmentation module (204) applies two methods to augment the Mel spectrogram: (i) multiplying a region on the Mel spectrogram (e.g., a few ms portion/chunk along the time axis, a few ms portion along the frequency axis, etc.) with a random value for augmentation (e.g., the “MWR” method) and (ii) replacing a region on the Mel spectrogram with a random value for augmentation (e.g., the “RWR” method).

In this process, the augmentation module (204) introduces noise directly to the Mel spectrogram (of input audio data). Assuming that the Mel spectrogram is in a logarithmic scale with “τ” time steps and “υ” Mel frequency channels, the augmentation module (204) may view the Mel spectrogram (see e.g., FIG. 4.1) as an image, in which the “frequency” axis is the vertical axis of the image and the “time” axis is the horizontal axis of the image.

Accordingly, the augmentation module (204) introduces four additional parameters as: (i) a time parameter “T”, (ii) a frequency parameter “F”, (iii) a parameter (“mt”) that denotes the number regions of the Mel spectrogram (along the time axis) that an augmentation is applied, and (iv) a parameter (“mf”) that denotes the number regions of the Mel spectrogram (along the frequency axis) that an augmentation is applied.

First, the augmentation module (204) may randomly choose four points within “(0, T), (0, v)” to perform augmentation. The augmentation module (204) may then choose a region to augment (RTA) for “frequency” and/or for “time”, which are uniformly sampled from “(0, F)” and “(0, T)”. Said another way, the augmentation module (204) may apply the MWR method or RWR method to (i) “[f0, f0+f], [f1, f1+f], etc.” consecutive Mel frequency channels and (ii) “[t0, t0+t], [t1, t1+t], etc.” consecutive time steps.

In one or more embodiments, in the MWR method, the augmentation module (204) multiplies the RTA with a masking value “m”, which is chosen randomly from the range “(a, b)” for each sample (or chunks) (where “a” and “b” are MWR parameters). The augmentation module (204) may then use this multiplied value to mask the RTA, where the RTA “after” the MWR method is a factor of the RTA “before” the MWR method.

Further, in the RWR method, the augmentation module (204) choses a masking value “r” randomly from the range “(minimum (input features of the batch), maximum (input features of the batch))” for each axis (where (i) the batch is a portion of training data including, for example, five audio chunks/clips, and (ii) an input feature is, for example, color depth, color tone, color intensity, etc., that represents variations in sound). This helps in regularizing the SRM better instead of using zeros for masking (e.g., using a constant value for masking). Further, the augmentation module (204) may perform the RWR method in two ways: (i) by considering the same “r” for all the utterances in the batch or (ii) by selecting an “r” for each utterance (which is “RWR per sample”).

In one or more embodiments, an audio signal may include one or more utterances (or audio utterances). As used herein, an “audio utterance” may refer to a unit of speech bounded by silence. The utterance may be a word, a clause, a sentence, or multiple sentences. Further, a “text utterance” may refer to a unit of speech (in a text form) that is provided by a customer or a computing system, in which the unit of speech may be a word, a clause, a sentence, or multiple sentences. Embodiments disclosed herein may apply to both types of utterances. Unless otherwise specified, “utterance” means either an audio utterance, a text utterance, or a combination thereof.

In one or more embodiments, after obtaining an augmented Mel spectrogram, the augmentation module (204) may provide the augmented Mel spectrogram to the feature encoder (206).

One of ordinary skill will appreciate that the augmentation module (204) may perform other functionalities without departing from the scope of the embodiments disclosed herein. The augmentation module (204) may be implemented using hardware, software, or any combination thereof.

In general, speech recognition is a “many-to-one” task (i.e., the temporal dimension of speech input is much higher compared to the text output). For example, sampling audio data in 16 kilohertz (kHz) means that 16,000 audio samples are taken per second. To this end, by employing a linear model, a non-linear model, and/or a ML model, the feature encoder (206) reduces the dimension of the audio data so that the data may be further processed easily (e.g., by the engine (208) and/or the masked correction module (210)).

In one or more embodiments, the feature encoder (206) may include, for example, a 7-layer one-dimensional (1D) convolutional neural network (CNN) with 512 channels at each layer, in which the kernel width and strides of the CNN layers may decrease as going forward in the network. Further, the feature encoder (206) may have, for example, a total receptive field of 400 samples or 25 ms of audio chunks (where the audio data may be encoded at a sample rate of 16 kHz).

In one or more embodiments, upon receiving/obtaining the augmented Mel spectrogram and by employing the aforementioned CNN (or the CNN model), the feature encoder (206) may use the augmented Mel spectrogram to extract one or more features and generate a sequence of feature vectors (e.g., embedding vectors, embeddings, etc.). The feature encoder (206) may then provide the feature vectors to the engine (208).

As used herein, an “embedding” is an ordered collection of numeric values that represents an input in a particular embedding space. For example, an embedding may be a vector of floating point or other numeric values that has a fixed dimensionality.

One of ordinary skill will appreciate that the feature encoder (206) may perform other functionalities without departing from the scope of the embodiments disclosed herein. The feature encoder (206) may be implemented using hardware, software, or any combination thereof.

In one or more embodiments, the engine (208) may include functionality to, e.g.,: (i) in conjunction with the analyzer (202), provide a useful ML-based framework to the administrator to at least assist the administrator for accurately detecting one or more anomalies in, for example, system logs (of a client) and to increase the administrator's performance (in terms of taking actions to (a) remediate hardware/software component related issues (occurred in the client) faster and/or (b) prevent any future hardware/software component related issues that may occur on the client); (ii) in conjunction with the analyzer (202), automate at least some of the “issue detection” tasks/duties assigned to the administrator for a better administrator experience; and/or (iii) in conjunction with the analyzer (202), analyze metadata (e.g., system logs, application logs, etc.) obtained from a client (a) to identify health (or health information) of each component of the client, (b) to tag/label each component as “healthy” or “unhealthy” for troubleshooting and optimization purposes (of the client), (c) to infer an overall health status of the client, and (d) to generate a device state path for the client (e.g., from a healthy device state to an unhealthy device state) (which may be useful for the administrator to infer how a hardware component failure has occurred (in the client) and to identify the various states that the client was in).

In one or more embodiments, the engine (208) may generate a device state chain (of a client) using a device state path (which corresponds to device states up to a current device state), a current device state, and a next device state of the client. As indicated, while generating the device state chain, not just the previous device state is considered, but the whole device state path is considered. For example, the engine (208) may generate a device state chain as A→B (where B is the current device state of a client) and B→C (where A represents “fan failure”, B represents “overheating of CPU”, and C represents “CPU failure”). In this example, the engine (208) (i) may calculate the probability of “A→B” in the device state chain as 0.2 and (ii) may calculate the probability of “B→C” in the device state chain as 0.3, where the probability of the device state chain “A→B→C” may be calculated as 0.06.

As discussed above, the engine (208) may infer a current device state of a device (e.g., a client) based on metadata (obtained from the client), in which the current device state may indicate a device state where a hardware component failure was reported. In one or more embodiments, the engine (208) may include a list of device states (associated with the client) where the client transitioned and, among the list of device states, a next device state may be the device state that has the highest probability to become the next device state.

In one or more embodiments, the engine (208) may initiate, for example, displaying of (i) identified/tagged health of a corresponding client, (ii) a holistic user profile of a user of the client, and/or (iii) analyzer generated alerts to an administrator (e.g., via a GUI, an API, a programmatic interface, a communication channel, etc.) to indicate an overall health status of the client. In one or more embodiments, for example, (i) each data item (e.g., identified health of the client, an analyzer generated alert, etc.) may be displayed (e.g., highlighted, visually indicated, etc.) with a different color (e.g., red color tones may represent a negative overall health status of the client, green color tones may represent a positive overall health status of the client, etc.), and (ii) one or more useful insights/recommendations with respect to the overall health status of the client may be displayed in a separate window(s) to assist the administrator while managing the overall health status of the client (e.g., for a better administrator experience, to help the administrator with respect to understanding the benefits and trade-offs of selecting different troubleshooting options, etc.).

Further, the engine (208) may include functionality to, e.g.,: (i) obtain/receive feature vectors from the feature encoder (206); (ii) by employing a linear model, a non-linear model, and/or a ML model, analyze the feature vectors to train an SRM; (iii) using the feature vectors, train the SRM to generate a trained SRM based on a target parameter (e.g., perform a speech recognition on limited annotated data using a certain amount of computing resource); and/or (iv) initiate notification of an administrator (of the IN (200)) about the trained SRM. Additional details of the engine are described below in reference to FIG. 2.2.

One of ordinary skill will appreciate that the engine (208) may perform other functionalities without departing from the scope of the embodiments disclosed herein. The engine (208) may be implemented using hardware, software, or any combination thereof.

In one or more embodiments, the masked correction module (210) aims to correct one or more errors (e.g., spelling errors, typographical errors, etc.) in the text output (or text sequences) received from the engine (208). Said another way, the masked correction module (210) may improve a transcription accuracy of the trained SRM (generated, trained, and employed by the engine (208)). The masked correction module (210) may employ a trained correction model (trained, at least, to correct a missing syllabus error caused by the trained SRM in the text (or text output)).

In one or more embodiments, the trained correction model may approach the “error correction” as an encoder-decoder task, where the encoder takes an incorrect sentence as input and the decoder generates a corrected sentence as output. In most cases, an error rate (or an error percentage) of an incorrect sentence is usually low (e.g., 10%) and because of that, traditional error correction models may only learn to correct limited error tokens (e.g., sub-words) (while trivially copying correct tokens). This may, in fact, harm the effective training of a traditional error correction model.

On the other hand, the error correction is a delicate task as the percentage of errors are usually very low. In most cases, because of this large imbalance, traditional error correction models tend to copy correct tokens and do not learn much from error tokens. This means that a traditional error correction model only learns performing a trivial copy mapping from input to output, which results in severely underuse of training data and low training accuracy/efficiency (of the model).

To this end, while obtaining the trained correction model, the masked correction module (210) intentionally and randomly masks/perturbs a part/portion of correct tokens (to generate one or more “special” tokens) so that (i) the utilization of correct tokens in training data is improved, (ii) the correction model will learn to not only correct the original error tokens (in the text received from the engine (208)) but also predict the “masked” tokens based on the special tokens (and/or context of corresponding tokens), (iii) the correction model will not trivially copy correct tokens and will not directly present them as the corrected output, and (iv) the low training efficiency problem of traditional models is resolved because special tokens do not contain explicit clues about the corresponding tokens (e.g., whether or not Word A and Word B are consecutive words, whether or not Word B is an antonym of Word F, etc.) and the correction model will be forced generate corrected output based on the special tokens (and/or context of corresponding tokens).

In one or more embodiments, after completing the error correction, the masked correction module (210) may provide corrected text output (e.g., the correspondence received from a customer) to a corresponding entity (e.g., a technical support person/specialist, a voice-based support agent, etc.).

One of ordinary skill will appreciate that the masked correction module (210) may perform other functionalities without departing from the scope of the embodiments disclosed herein. The masked correction module (210) may be implemented using hardware, software, or any combination thereof.

Separately, in general, traditional SRMs have hundreds of millions of parameters and because of that, those models require lots of data. Without enough data, a traditional model may quickly overfit and may not operate as expect in out-of-domain business scenarios. For the model to operate as expected, the model may need to have knowledge about the business context/scenario to infer all the spoken terms correctly. To this end, the model cannot be an off-the-shelf model.

On the other hand, fine-tuning the model may require a large amount of speech data and annotating that data may be expensive (in terms of, for example, time and computing resource). To overcome the aforementioned issues, one or more embodiments may employ a modified self-training process (e.g., a noisy training process) via the feature encoder (206) and the engine (208), in which the engine and feature encoder use labeled/annotated data as well as unlabeled data in an iterative way to help domain adaptation of the SRM using limited annotated data.

For example, a smaller version of the SRM (employed by the engine (208)) may be trained first (along with the feature encoder (206)) on 5-hour of annotated data (where this model will be the base model to build upon). The unlabeled data may be split into multiple subsets, where the trained model (or the base model) may be used to predict a subset of the unlabeled data. If the base model's prediction is above a predetermined threshold (that shows a confidence level of the prediction), transcripts associated with the subset of the unlabeled data are used to complement/update the already existing annotated data. The updated annotated data may then be used to train a larger version of the SRM (along with the feature encoder (206)). While training the SRM, one or more embodiments may also introduce certain noises to the SRM in the form of dropouts and/or augmentations. The “trained” larger version of the SRM may then form the base to generate one or more transcripts for the next set of unlabeled data, and a newer SRM may be trained (with noise) on a larger annotated data set. This process may continue until convergence is achieved.

Further, different kind of noise may have different kinds of effects (e.g., on the model that is being trained). For example, when augmentation is used to introduce noise, the model may be forced to learn transcribing non-augmented audio data and augmented audio data in the same way. As yet another example, when dropout is used to introduce noise, the model may act as an ensemble of models. To this end, this iterative noisy training process (e.g., a modified self-supervised learning method) helps the engine (208) to generate a robust trained SRM (which even operates with limited annotated data).

In one or more embodiments, the analyzer (202), the augmentation module (204), the feature encoder (206), the engine (208), and the masked correction module (210) may be utilized in isolation and/or in combination to provide the aforementioned functionalities. These functionalities may be invoked using any communication model including, for example, message passing, state sharing, memory sharing, etc.

Turning now to FIG. 2.2, FIG. 2.2 shows a diagram of the engine (208) in accordance with one or more embodiments disclosed herein. The engine (208) includes, at least, a linear layer, a dropout layer (or a “dropout”), a multi-head self-attention layer (or a “multi-head self-attention”), a convolution layer, a feed forward network, and a layer normalization component (or a “layer normalization”). The engine (208) may include additional, fewer, and/or different components/layers without departing from the scope of the embodiments disclosed herein. Each component may be operably connected to any of the other component via any combination of wired and/or wireless connections. Each component illustrated in FIG. 2.2 is discussed below.

In general, traditional SRMs widely use the transformer architecture (which is based on “self-attention”) as this architecture is able to model one or more speech sequences because of its (i) ability to capture long distance interactions (e.g., long-range global context) and (ii) high training efficiency. Alternatively, CNNs have also been successful for SRMs, in which a CNN can capture local context/interactions progressively via a local receptive field layer by layer. However, each approach (i.e., the transformer approach and CNN approach) has its own limitations.

While the transformer approach is useful at modeling long-range interactions, this approach is less capable to extract fine-grained local feature patterns from limited amount of data (e.g., slight changes in color intensity in the augmented Mel spectrogram). On the other hand, the CNN approach (i) is useful to exploit local information (e.g., using local connectivity), (ii) learns using shared position-based kernels over a local window (while maintaining translation equivariance), and (iii) is able to capture features like edges and shapes. However, the CNN approach is limited in terms of using local connectivity, where one may need more layers (and/or parameters) to capture long-range global context.

For at least the aforementioned reasons and to generate an efficient SRM, the engine (208) generates the SRM as a combination of a multi-head self-attention layer and a convolution layer, in which (i) the multi-head self-attention layer employs a relative sinusoidal positional encoding scheme and (ii) the convolution layer employs, at least, a pointwise convolution, a 1D depthwise convolution, a swish activation, and a gated linear unit (GLU) activation. To this end, the SRM is able to learn both position-wise local features (e.g., where each utterance may have a certain position on the time axis of the augmented Mel spectrogram) and use context-based global interactions (because processing an audio sequence that has a high temporal dimension requires considering both local features and global interactions), in which the multi-head self-attention layer learns the global interactions while the convolution layer captures the relative-offset-based local features/correlations.

Referring to FIG. 2.2 (left side), output of the feature encoder (206) (or input of the engine (208)) (e.g., the feature vectors) may have a dimension of 1024. In one or more embodiments, in the SRM, the engine (208) may use a linear layer to reduce the dimension of each feature vector from 1024 to, for example, 128 to make the SRM (and the whole framework) more computationally efficient (e.g., computing resource friendly). The engine (208) may then use the dropout to improve the overall SRM performance and reduce overfitting (e.g., by dropping out certain percentage of input and hidden units/nodes/layers during the training process).

In one or more embodiments, the multi-head self-attention, convolution layer, and feed forward network may be stacked together (with one or more skip connections) to form a stacked structure and the SRM may include “N” number of these structures. As described above, the multi-head self-attention layer may employ a relative sinusoidal positional encoding scheme, where the scheme allows the layer to generalize better on different input length of audio chunks (so that the layer becomes more robust to the variance of the input length (or the utterance length)). Further, the multi-head self-attention layer employs one or more residual units (not shown), which facilitates training and regularizing the SRM (e.g., balancing overfitting and underfitting of the SRM during training).

Referring to FIG. 2.2 (right side) and as described above, the convolution layer employs, at least, a pointwise convolution, a 1D depthwise convolution, a swish activation (or a swish activation function), and a GLU activation. The convolution layer may start with a gating mechanism (including a layer normalization (to aid training of the SRM)), a pointwise convolution, and the GLU activation. This may be followed by the 1D depthwise convolution, where the use of pointwise convolution and depthwise convolution may reduce the number of required computations (compared to a normal convolution) to make the convolution layer more efficient. Thereafter, the convolution layer may employ the swish activation (e.g., to introduce non-linearity to the convolution layer), which is followed by a pointwise convolution.

In one or more embodiments, output of the stacked structure may be provided to the layer normalization to aid training of the SRM (because after each iteration while training the SRM, one or more model parameters/weights may be tuned). The layer normalization may generate a text (as part of the speech-to-text process), where, at the end, by employing the SRM, the engine (208) converts the feature vectors (e.g., associated with the augmented Mel spectrogram) to the text. Referring to FIG. 2.1, the engine (208) may then provide the text to the masked correction module (210) for further processing.

Turning now to FIG. 3.1, FIG. 3.1 shows an example transcript of an audio file (or an audio file chunk) in accordance with one or more embodiments disclosed herein. Referring to FIG. 3.1, each party (e.g., the agent and customer) is tagged accordingly (for at least model training purposes).

Turning now to FIG. 3.2, FIG. 3.2 shows an example transcript of an audio file (or an audio file chunk) in accordance with one or more embodiments disclosed herein. Referring to FIG. 3.2 and similar to FIG. 3.1, each party is tagged accordingly (for at least model training purposes). Further, the audio files chunks illustrated in FIGS. 3.1 and 3.2 (e.g., “sample audio 0024” and “sample audio 0025”) may be obtained after splitting corresponding audio data into those chunks.

Turning now to FIG. 3.3, FIG. 3.3 shows an example transcript of an audio file (or an audio file chunk) in accordance with one or more embodiments disclosed herein. Referring to FIG. 3.3, each party (e.g., the agent and customer) is tagged accordingly (for at least model training purposes).

Turning now to FIG. 3.4, FIG. 3.4 shows an example transcript of an audio file (or an audio file chunk) in accordance with one or more embodiments disclosed herein. Referring to FIG. 3.4 and similar to FIG. 3.3, each party is tagged accordingly (for at least model training purposes). Further, the audio files chunks illustrated in FIGS. 3.3 and 3.4 (e.g., “sample audio 0039” and “sample audio 0040”) may be obtained after splitting corresponding audio data into those chunks.

Turning now to FIG. 4.1, FIG. 4.1 shows an example audio signal converted to a Mel spectrogram in accordance with one or more embodiments disclosed herein. Referring to FIG. 4.1, the Mel spectrogram can be considered as an image, where the image includes a horizontal axis specifying time information associated with audio data and a vertical axis specifying frequency information associated with the audio data. Further, because the Mel spectrogram uses the “decibel scale” instead of “amplitude” to indicate colors, the color bar shown in FIG. 4.1 indicates/visualizes loudness in terms of decibel.

Turning now to FIG. 4.2, FIG. 4.2 shows an example Mel spectrogram in accordance with one or more embodiments disclosed herein. Referring to FIG. 4.2 and similar to FIG. 4.1, the Mel spectrogram can be considered as an image, where the image includes a horizontal axis specifying time information associated with audio data and a vertical axis specifying frequency information associated with the audio data.

Turning now to FIG. 4.3, FIG. 4.3 shows an example augmented Mel spectrogram in accordance with one or more embodiments disclosed herein. Referring to FIGS. 4.2 and 4.3, the Mel spectrogram illustrated in FIG. 4.3 is obtained by augmenting the “original” Mel spectrogram illustrated in FIG. 4.2. As indicated, the “augmented” Mel spectrogram is obtained (i) by multiplying a first region (e.g., a random pixel(s) along the horizontal axis) with a first random value (e.g., 0.2) and (ii) by multiplying a second region (e.g., a random pixel(s) along the vertical axis) with a second random value (e.g., 0.05). Said another way, in order to introduce a first noise to the “original” Mel spectrogram, the first region (which may be a few ms long along the horizontal axis) is multiplied with the first random value, and similarly, in order to introduce a second noise to the Mel spectrogram, the second region (which may be a few ms long along the vertical axis) is multiplied with the second random value.

Turning now to FIG. 4.4, FIG. 4.4 shows an example augmented Mel spectrogram in accordance with one or more embodiments disclosed herein. Referring to FIGS. 4.2 and 4.4, the Mel spectrogram illustrated in FIG. 4.4 is obtained by augmenting the “original” Mel spectrogram illustrated in FIG. 4.2. As indicated, the “augmented” Mel spectrogram is obtained (i) by replacing a first region (e.g., a random pixel(s) along the horizontal axis) with a first random value and (ii) by replacing a second region (e.g., a random pixel(s) along the vertical axis) with a second random value. Said another way, in order to introduce a first noise to the “original” Mel spectrogram, the first region (which may be a few ms long along the horizontal axis) is replaced with the first random value, and similarly, in order to introduce a second noise to the Mel spectrogram, the second region (which may be a few ms long along the vertical axis) is replaced with the second random value.

FIGS. 5.1 and 5.2 show a method for generating a trained SRM in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 5.1, the method shown in FIG. 5.1 may be executed by, for example, the above-discussed analyzer (e.g., 202, FIG. 2.1), augmentation module (e.g., 204, FIG. 2.1), and feature encoder (e.g., 206, FIG. 2.1). Other components of the system (100) illustrated in FIG. 1 may also execute all or part of the method shown in FIG. 5.1 without departing from the scope of the embodiments disclosed herein.

In Step 500, the analyzer receives a request from a requesting entity (e.g., an administrator via an administrator terminal, an application, etc.) that wants to generate a trained SRM (e.g., an ML model) that, at least, performs speech recognition.

In response to receiving the request, as part of that request, and/or in any other manner (e.g., before initiating any computation with respect to the request, to train the SRM, etc.), the analyzer invokes the database (e.g., 135, FIG. 1) to communicate with the database. After receiving the database's confirmation, the analyzer obtains audio data and its transcript (e.g., a large corpus of agent-customer conversation including labeled and unlabeled data, information (e.g., an identifier of a customer, an identifier of a support agent, etc.) associated with a portion of the audio data, etc.) from the database. In one or more embodiments, the aforementioned data may be obtained continuously or at regular intervals (e.g., every 5 hours) (without affecting production workloads of the database and the analyzer). Further, the aforementioned data may be access-protected for the transmission from, for example, the database to the analyzer, e.g., using encryption.

In one or more embodiments, the aforementioned data may be obtained as it becomes available or by the analyzer polling the database (via one or more API calls) for newer information. For example, based on receiving an API call from the analyzer, the database may allow the analyzer to obtain newer information.

In Step 502, by employing a set of linear, non-linear, and/or ML models, the analyzer converts the audio data to a Mel spectrogram. In one or more embodiments, the analyzer may store (temporarily or permanently) the Mel spectrogram to the database. Further, the analyzer may provide the transcript to the feature encoder. Details of the Mel spectrogram are described above in reference to FIGS. 4.1-4.4. In Step 504, the analyzer provides the Mel spectrogram to the augmentation module.

In Step 506, the augmentation module augments a first region of the Mel spectrogram by multiplying the first region with a first random value. Details of a region and multiplication with a random value are described above in reference to FIGS. 2.1, 4.2, and 4.3. In Step 508, the augmentation module augments a second region of the Mel spectrogram by replacing the second region with a second random value. Details of a region and replacement with a random value are described above in reference to FIGS. 2.1, 4.2, and 4.4. In one or more embodiments, after Step 508, the augmentation module obtains an augmented Mel spectrogram.

In Step 510, the augmentation module provides the augmented Mel spectrogram to the feature encoder. In Step 512, by employing a set of linear, non-linear, and/or ML models (e.g., single modality embedding transform models, multimodal embedding transform models, etc.), the feature encoder analyzes the augmented Mel spectrogram and transcript to generate a sequence of feature vectors. Thereafter, in Step 514, the feature encoder provides the feature vectors to the engine.

Turning now to FIG. 5.2, the method shown in FIG. 5.2 may be executed by, for example, the above-discussed engine. Other components of the system (100) illustrated in FIG. 1 may also execute all or part of the method shown in FIG. 5.2 without departing from the scope of the embodiments disclosed herein.

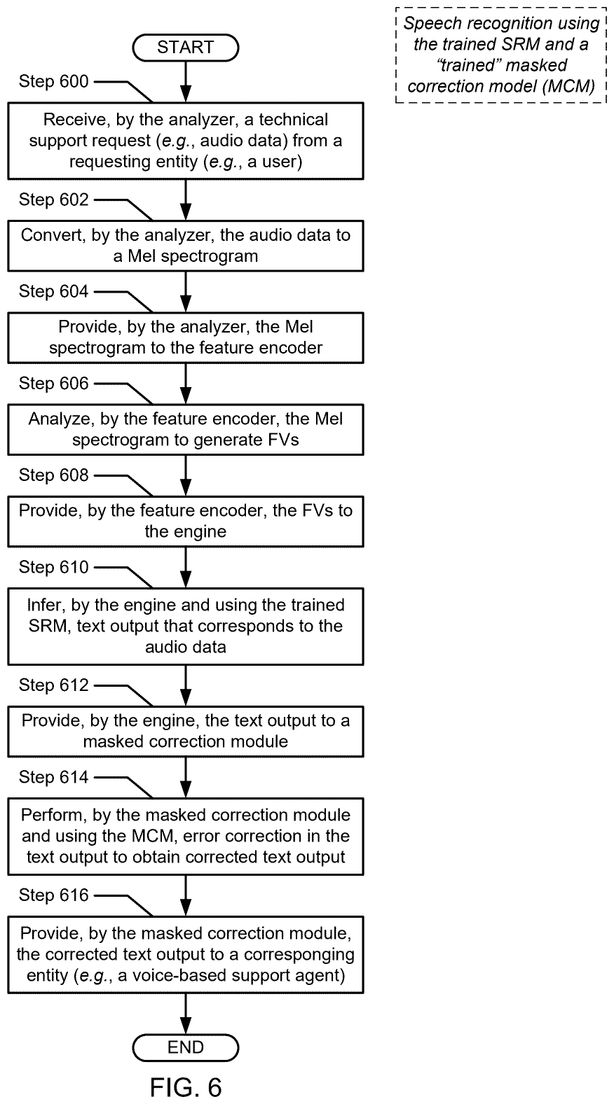

In Step 516, by employing a set of linear, non-linear, and/or ML models, the engine analyzes the feature vectors (generated in Step 512 of FIG. 5.1) to train the SRM. In Step 518, (i) based on the target variable/parameter and instructions, and (ii) using the feature vectors, the engine trains the SRM to obtain a “trained” SRM. In one or more embodiments, the “trained” SRM may then be used for inferencing purposes (or for the “inferencing phase”, see FIG. 6).

In one or more embodiments, the trained SRM may be adapted to execute specific determinations described herein with reference to any component of the system (e.g., 100, FIG. 1) and processing operations executed thereby.

In one or more embodiments, as the trained SRM is a learning model, accuracy of the model may be improved over time through iterations of training, receipt of user feedbacks, etc. Further, training the SRM may include application of a training algorithm (e.g., the noisy training algorithm, a decision tree algorithm, etc.). As an example, a decision tree (e.g., a Gradient Boosting Decision Tree) may be used to train the SRM. In doing so, one or more types of decision tree algorithms may be applied for generating any number of decision trees to fine-tune the SRM. In one or more embodiments, training of the SRM may further include generating an ML model that is tuned to reflect specific metrics for accuracy, precision and/or recall before the trained ML model is exposed for real-time (or near real-time) usage (see FIG. 6). Additional details of the training process (of the SRM) are described above in reference to FIGS. 2.1 and 2.2.

In Step 520, after generating the trained SRM (in Step 518) (e.g., after the SRM is ready for inferencing), the engine initiates notification of an administrator/user (of a corresponding IN (e.g., 200, FIG. 2.1)) about the generated and trained SRM. The notification may include, for example (but not limited to): for what purpose the model has been trained, the type of data that has been taken into account while training the model, the amount of time that has been spent while performing the training process, etc.

In one or more embodiments, the notification may also indicate whether the training process was completed within the predetermined window, or whether the process was completed after exceeding the predetermined window. The notification may be displayed on a GUI of the IN. In one or more embodiments, the method may end following Step 520.

FIG. 6 shows a method for performing speech recognition (e.g., during a technical support conversation with a customer) using the trained SRM (generated in FIGS. 5.1 and 5.2) and a “trained” masked correction model (or a “trained” correction model) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 6, the method shown in FIG. 6 may be executed by, for example, the above-discussed analyzer, feature encoder, engine, and masked correction module (e.g., 210, FIG. 2.1). Other components of the system (100) illustrated in FIG. 1 may also execute all or part of the method shown in FIG. 6 without departing from the scope of the embodiments disclosed herein.

In Step 600, the analyzer receives a request (e.g., a technical support request) from a requesting entity (e.g., a customer/user). The customer may send the request, for example, because of a technical support issue occurred in a client (e.g., 110A, 110N, etc.) and/or an alert triggered in the client. In one or more embodiments, the technical support issue may be, for example (but not limited to): a printed circuit board (PCB) failure, overheating of a DPU, etc. Separately, the alert may specify, for example (but not limited to): a GPU overheating is detected, a recommended maximum GPU operating temperature is exceeded, etc. Further, the request (e.g., audio data including technical support correspondence) may include, for example (but not limited to): information related to a technical support issue, information related to a technical alert, information related to a customer (e.g., an identifier of a customer, a product number of the client, etc.), etc.

In response to receiving the request, as part of that request, and/or in any other manner (e.g., before initiating any computation with respect to the request), the analyzer may generate a support ticket and identify one or more keywords from the request to generate a “technical support request tag” specifying the subject of a soon-to-start technical support session. The keyword identification may be implemented using any mechanism without departing from the scope of the embodiments disclosed herein.

In Step 602, by employing a set of linear, non-linear, and/or ML models, the analyzer converts the audio data to a Mel spectrogram. In one or more embodiments, the analyzer may store (temporarily or permanently) the Mel spectrogram to the database. In Step 604, the analyzer provides the Mel spectrogram to the feature encoder. In Step 606, by employing a set of linear, non-linear, and/or ML models, the feature encoder analyzes the Mel spectrogram to generate a sequence of feature vectors. Thereafter, in Step 608, the feature encoder provides the feature vectors to the engine.

In Step 610, (i) upon obtaining/receiving the feature vectors and (ii) by employing the trained SRM, the engine infers text output that corresponds to the audio data (received as part of or along with the request in Step 600).

In one or more embodiments, if the trained SRM is not operating properly (e.g., is not providing the above-discussed functionalities), the model may be re-trained using any form of training data and/or the model may be updated periodically as there are improvements in the model (e.g., the model may be trained using more appropriate training data). In one or more embodiments, upon inferring the text output, the engine may store (temporarily or permanently) a copy of the text output to the database.

In Step 612, the engine provides the text output to the masked correction module. In Step 614, by employing the trained correction model, the masked correction module performs error correction in the text output to obtain corrected text output. Details of the error correction are described above in reference to FIG. 2.1.

After obtaining the corrected text output, if necessary, the masked correction module may clean the corrected text output to obtain a “cleaned” corrected text output. Further, after the cleaning (if it was performed), the masked correction module may make a determination as to whether the corrected text output is in a default/common language (for example, in order to facilitate sharing of the corrected text output (once the technical support session is ended)). To this end, if the corrected text output is not in the default language, the masked correction module may translate the output into the default language (e.g., English).

In Step 616, the masked correction module provides the corrected text output to a corresponding entity (e.g., a voice-based customer support agent, a technical support person, etc.). In one or more embodiments, the method may end following Step 616.

Turning now to FIG. 7, FIG. 7 shows a diagram of a computing device in accordance with one or more embodiments disclosed herein.

In one or more embodiments disclosed herein, the computing device (700) may include one or more computer processors (702), non-persistent storage (704) (e.g., volatile memory, such as RAM, cache memory), persistent storage (706) (e.g., a non-transitory computer readable medium, a hard disk, an optical drive such as a CD drive or a DVD drive, a Flash memory, etc.), a communication interface (712) (e.g., Bluetooth interface, infrared interface, network interface, optical interface, etc.), an input device(s) (710), an output device(s) (708), and numerous other elements (not shown) and functionalities. Each of these components is described below.

In one or more embodiments, the computer processor(s) (702) may be an integrated circuit for processing instructions. For example, the computer processor(s) (702) may be one or more cores or micro-cores of a processor. The computing device (700) may also include one or more input devices (710), such as a touchscreen, keyboard, mouse, microphone, touchpad, electronic pen, or any other type of input device. Further, the communication interface (712) may include an integrated circuit for connecting the computing device (700) to a network (e.g., a LAN, a WAN, Internet, mobile network, etc.) and/or to another device, such as another computing device.

In one or more embodiments, the computing device (700) may include one or more output devices (708), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a technical support conversation, the method comprising:
obtaining, by an analyzer, an audio data and a transcript associated with the audio data;
converting, by the analyzer, the audio data to a Mel spectrogram (MS), wherein the MS is provided to an augmentation module (AM), wherein the transcript is provided to a feature encoder;
augmenting, by the AM, the MS to obtain an augmented MS, wherein the augmented MS is provided to the feature encoder and wherein the augmenting comprises:
in a first region of the MS, multiplying the first region with a first random value, and
in a second region of the MS, replacing the second region with a second random value to obtain the augmented MS;
analyzing, by the feature encoder, the augmented MS and the transcript to generate a set of feature vectors (FVs), wherein the set of FVs is provided to an engine;
analyzing, by the engine, the set of FVs to train a speech recognition model (SRM);
training, by the engine and using the set of FVs, the SRM to generate a trained SRM based on a target parameter;
inferring, by the engine and using the trained SRM, a text output that corresponds to a second audio data received from a customer, wherein the text output is provided to a masked correction module (MCM);
performing, by the MCM and using a correction model, an error correction in the text output to obtain a corrected text output; and
providing, by the MCM, the corrected text output to a corresponding entity.

2. The method of claim 1, wherein at least a portion of the audio data is annotated, wherein the transcript comprises information associated with the portion of the audio data, and wherein the information specifies at least an identifier of a second customer and a second identifier of a voice-based customer support agent.

3. The method of claim 1, wherein the SRM is a combination of a multi-head self-attention layer and a convolution layer, wherein the multi-head self-attention layer employs a relative sinusoidal positional encoding scheme, and wherein the convolution layer employs at least a pointwise convolution, a depthwise convolution, and a gated linear unit (GLU).

4. The method of claim 1,
wherein the MS is an image comprising a horizontal axis specifying a time information associated with the audio data and a vertical axis specifying a frequency information associated with the audio data, and
wherein the first region is along the horizontal axis and the second region is along the vertical axis.

5. The method of claim 4,
wherein, in order to introduce a first noise to the MS, the first region is multiplied with the first random value, and
wherein, in order to introduce a second noise to the MS, the second region is replaced with the second random value.

6. The method of claim 1, wherein the target parameter specifies performing a speech recognition on a limited annotated data using a certain amount of computing resource.

7. The method of claim 1, wherein the corresponding entity is a voice-based customer support agent.

8. The method of claim 1,
wherein the correction model is used to improve a transcription accuracy of the trained SRM, and
wherein the correction model is trained to correct at least a missing syllabus error caused by the trained SRM in the text output.

9. A method for managing a technical support conversation, the method comprising:
obtaining, by an analyzer, an audio data and a transcript associated with the audio data;
converting, by the analyzer, the audio data to a Mel spectrogram (MS), wherein the MS is provided to an augmentation module (AM), wherein the transcript is provided to a feature encoder;
augmenting, by the AM, the MS to obtain an augmented MS, wherein the augmented MS is provided to the feature encoder and wherein the augmenting comprises:
in a first region of the MS, multiplying the first region with a first random value, and
in a second region of the MS, replacing the second region with a second random value to obtain the augmented MS;
analyzing, by the feature encoder, the augmented MS and the transcript to generate a set of feature vectors (FVs), wherein the set of FVs is provided to an engine;
analyzing, by the engine, the set of FVs to train a speech recognition model (SRM);
training, by the engine and using the set of FVs, the SRM to generate a trained SRM based on a target parameter; and
initiating, by the engine, notification of an administrator about the trained SRM.

10. The method of claim 9, further comprising:
after the notification of the administrator:
receiving, by the analyzer, a technical support request from a requesting entity, wherein the request comprises a second audio data;
converting, by the analyzer, the second audio data to a second MS, wherein the second MS is provided to the feature encoder;
analyzing, by the feature encoder, the second MS to generate a second set of FVs, wherein the second set of FVs is provided to the engine;
inferring, by the engine and using the trained SRM, a text output that corresponds to the second audio data, wherein the text output is provided to a masked correction module (MCM);
performing, by the MCM and using a correction model, an error correction in the text output to obtain a corrected text output; and
providing, by the MCM, the corrected text output to the requesting entity.

11. The method of claim 10, wherein the requesting entity is a voice-based customer support agent.

12. The method of claim 10,
wherein the correction model is used to improve a transcription accuracy of the trained SRM, and
wherein the correction model is trained to correct at least a missing syllabus error caused by the trained SRM in the text output.

13. The method of claim 9, wherein the SRM is a combination of a multi-head self-attention layer and a convolution layer, wherein the multi-head self-attention layer employs a relative sinusoidal positional encoding scheme, and wherein the convolution layer employs at least a pointwise convolution, a depthwise convolution, and a gated linear unit (GLU).

14. The method of claim 9,
wherein the MS is an image comprising a horizontal axis specifying a time information associated with the audio data and a vertical axis specifying a frequency information associated with the audio data, and
wherein the first region is along the horizontal axis and the second region is along the vertical axis.

15. The method of claim 14,
wherein, in order to introduce a first noise to the MS, the first region is multiplied with the first random value, and
wherein, in order to introduce a second noise to the MS, the second region is replaced with the second random value.

16. The method of claim 9, wherein the target parameter specifies performing a speech recognition on a limited annotated data using a certain amount of computing resource.

17. A method for managing a technical support conversation, the method comprising:
receiving, by an analyzer, a technical support request from a requesting entity, wherein the request comprises an audio data;
converting, by the analyzer, the audio data to a Mel spectrogram (MS), wherein the MS is provided to a feature encoder;
analyzing, by the feature encoder, the MS to generate a set of feature vectors (FVs), wherein the set of FVs is provided to an engine;
inferring, by the engine and using a trained speech recognition model (SRM), a text output that corresponds to the audio data, wherein the text output is provided to a masked correction module (MCM);
performing, by the MCM and using a correction model, an error correction in the text output to obtain a corrected text output; and
providing, by the MCM, the corrected text output to the requesting entity.

18. The method of claim 17, further comprising:
prior to the receiving the technical support request:
obtaining, by the analyzer, a second audio data and a transcript associated with the second audio data;
converting, by the analyzer, the second audio data to a second MS, wherein the second MS is provided to an augmentation module (AM), wherein the transcript is provided to the feature encoder;
augmenting, by the AM, the MS to obtain an augmented MS, wherein the augmented MS is provided to the feature encoder and wherein the augmenting comprises:
in a first region of the second MS, multiplying the first region with a first random value, and
in a second region of the second MS, replacing the second region with a second random value to obtain the augmented MS;
analyzing, by the feature encoder, the augmented MS and the transcript to generate a second set of FVs, wherein the second set of FVs is provided to the engine;
analyzing, by the engine, the second set of FVs to train an SRM;
training, by the engine and using the second set of FVs, the SRM to generate the trained SRM based on a target parameter; and
initiating, by the engine, notification of an administrator about the trained SRM.

19. The method of claim 17,
wherein the correction model is used to improve a transcription accuracy of the trained SRM, and
wherein the correction model is trained to correct at least a missing syllabus error caused by the trained SRM in the text output.

20. The method of claim 18, wherein the SRM is a combination of a multi-head self-attention layer and a convolution layer, wherein the multi-head self-attention layer employs a relative sinusoidal positional encoding scheme, and wherein the convolution layer employs at least a pointwise convolution, a depthwise convolution, and a gated linear unit (GLU).
